(19) United States
(12) Patent Application Publication
(10) Pub. No.: US 2026/0104790 A1
(43) Pub. Date: Apr. 16, 2026

(54) SYSTEM AND METHOD FOR FLIGHT NAVIGATION USER INTERFACE

(71) Applicant: The Boeing Company, Arlington, VA (US)

(72) Inventors: Drew Carver, Tampa, FL (US); Chris St. Amant, Anoka, MN (US)

(21) Appl. No.: 19/354,370

(22) Filed: Oct. 9, 2025

Related U.S. Application Data
(60) Provisional application No. 63/705,752, filed on Oct. 10, 2024.

(51) Int. Cl. G06F 3/04886; B64D 47/00; G01C 21/20; G06F 3/04845

(52) U.S. Cl. CPC G06F 3/04886; G01C 21/20; G06F 3/04845; B64D 47/00

(57) ABSTRACT

Systems and methods for entry of navigation coordinate data in a flight navigation platform with a graphical user interface are provided. One method comprises determining an anchored reach region of a touch-screen display; displaying, on the touch-screen display, one of a plurality of data entry keyboards, each keyboard comprising a keyboard selection key; and responsive to a user input via said key, selectively displaying another one of the plurality of data entry keyboards, said keyboards comprising an alphanumeric data keyboard and a condensed coordinate data keyboard. Another method comprises displaying, on a touch-screen display, a condensed coordinate data keyboard for entry of navigation coordinate data, said keyboard comprising an arrangement selection key; and responsive to a user input via said key, altering, on the touch-screen display, a key arrangement of the condensed coordinate data keyboard between a left justified arrangement of keys and a right justified arrangement of keys.

### BACKGROUND

Navigation systems provide helpful assistance to pilots for route mapping and planning information. When the navigation system includes a touch-screen display, a user may have difficulty entering navigation coordinate data with their hand in a free-floating manner, for example, due to aircraft maneuvering or turbulence. Some users anchor their hand for a more stable, but fixed base from which to enter the navigation coordinate data. However, this fixed base can make certain keys displayed on the touch-screen display difficult to reach.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure are directed to a method for entry of navigation coordinate data for a flight navigation platform with a graphical user interface. The method includes determining an anchored reach region of a touch-screen display; and causing the touch-screen display to display one of a plurality of data entry keyboards. The plurality of data entry keyboards includes an alphanumeric data keyboard comprising first letter keys arranged in a QWERTY configuration and number keys arranged in a horizontal row above an uppermost horizontal row of the QWERTY configuration, in which each of the number keys is horizontally aligned with a letter key of the uppermost horizontal row. The plurality of data entry keyboards also includes a condensed coordinate data keyboard comprising the number keys arranged in a grid configuration, second letter keys including letters N, S, E, and W that are arranged linearly adjacent to the grid configuration, and symbol keys including navigation coordinate symbols for plus, minus, degrees, minutes, and seconds. Each of the plurality of data entry keyboards further comprises a keyboard selection key. The method further includes selectively causing the touch-screen display to display another of the plurality of data entry keyboards responsive to a user input via the keyboard selection key.

Aspects of the present disclosure are directed to a method for entry of navigation coordinate data for a flight navigation platform with a graphical user interface. The method includes causing a touch-screen display to display a condensed coordinate data keyboard for entry of navigation coordinate data. The condensed coordinate data keyboard includes number keys arranged in a grid configuration, cardinal direction keys located adjacent to the grid configuration, and symbol keys comprising navigation coordinate symbols for plus (+), minus (−), degrees (°), minutes (′), and seconds (″), and an arrangement selection key. The method also includes, responsive to user inputs via the arrangement selection key, altering a key arrangement of the condensed coordinate data keyboard between a left justified arrangement of keys and a right justified arrangement of keys.

Aspects of the present disclosure are directed to a method for entry of navigation coordinate data for a flight navigation platform. The method includes causing a touch-screen display to display a condensed coordinate data keyboard having cardinal direction keys, number keys of only digits zero through nine, symbol keys comprising navigation coordinate symbols for plus, minus, degrees, minutes, and seconds, and an arrangement selection key. The method also includes, responsive to user inputs via the arrangement selection key, dynamically altering a key arrangement of the condensed coordinate data keyboard between a left justified arrangement of keys and a right justified arrangement of keys. The right justified arrangement positions the number keys on a right portion of the touch-screen display and the left justified arrangement positions the number keys on a left portion of the touch-screen display.

Aspects of the present disclosure are directed to a system for entry of navigation coordinate data in a flight navigation platform, the system comprising: one or more processors; a touch-screen display communicatively coupled to the one or more processors; and a memory storing instructions that are operative, upon execution by the one or more processors, to cause the one or more processors to: display, on the touch-screen display, a condensed coordinate data keyboard having cardinal direction keys, number keys of only digits zero through nine, symbol keys comprising navigation coordinate symbols for plus, minus, degrees, minutes, and seconds, and an arrangement selection key; and responsive to a user input received via the arrangement selection key, dynamically alter, on the touch-screen display, a key arrangement of the condensed coordinate data keyboard between a left justified arrangement of keys and a right justified arrangement of keys, wherein the right justified arrangement positions the number keys on a right portion of the touch-screen display and the left justified arrangement positions the number keys on a left portion of the touch-screen display.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS/FIGURES

Non-limiting and non-exhaustive examples are described with reference to the following Figures.

FIG. 1 is a block diagram of an electronic user device for a flight navigation platform configured to provide different data entry keyboards, according to an implementation.

FIG. 2 is a diagram of the electronic user device of FIG. 1 and illustrating a portrait orientation of an abridged alphanumeric data keyboard according to an implementation.

FIG. 3 is a diagram of the electronic user device of FIG. 1, illustrating a portrait orientation of a condensed coordinate data keyboard having a left justified arrangement of keys according to an implementation.

FIG. 4 is a diagram of the electronic user device of FIG. 1, illustrating the portrait orientation of the condensed coordinate data keyboard having the left justified arrangement of keys with a left anchored user hand according to an implementation.

FIG. 5 is a diagram of the electronic user device of FIG. 1, illustrating the portrait orientation of the condensed coordinate data keyboard having the left justified arrangement of keys with a left anchored reach region according to an implementation.

FIG. 6 is a diagram of the electronic user device of FIG. 1, illustrating a portrait orientation of a condensed coordinate data keyboard having a right justified arrangement of keys according to an implementation.

FIG. 7 is a diagram of the electronic user device of FIG. 1, illustrating the portrait orientation of the condensed coordinate data keyboard having the right justified arrangement of keys with a right anchored user hand according to an implementation.

FIG. 8 is a diagram of the electronic user device of FIG. 1, illustrating the portrait orientation of the condensed coordinate data keyboard having the right justified arrangement of keys with a right anchored reach region according to an implementation.

FIG. 9 is a diagram of the electronic user device of FIG. 1, illustrating a landscape orientation of an abridged alphanumeric data keyboard according to an implementation.

FIG. 10 is a diagram of the electronic user device of FIG. 1, illustrating a landscape orientation of a condensed coordinate data keyboard having a left justified arrangement of keys according to an implementation.

FIG. 11 is a diagram of the electronic user device of FIG. 1, illustrating a landscape orientation of a condensed coordinate data keyboard having a right justified arrangement of keys according to an implementation.

FIG. 12 is a diagram of another electronic user device for a flight navigation platform configured to provide different data entry keyboards and illustrating a portrait orientation of an abridged alphanumeric data keyboard according to an implementation.

FIG. 13 is a diagram of the electronic user device of FIG. 12, illustrating a landscape orientation of an abridged alphanumeric data keyboard according to an implementation.

FIG. 14 is a diagram of another condensed coordinate data keyboard having a left justified arrangement of keys in a portrait orientation according to an implementation.

FIG. 15 is a diagram of another condensed coordinate data keyboard having a right justified arrangement of keys in a portrait orientation according to an implementation.

FIG. 16 is a diagram of another condensed coordinate data keyboard having a left justified arrangement of keys in a landscape orientation according to an implementation.

FIG. 17 is a diagram of another condensed coordinate data keyboard having a right justified arrangement of keys in a landscape orientation according to an implementation.

FIG. 18 is a diagram of a method of displaying a data entry keyboard according to an implementation.

FIG. 19 is a schematic perspective view of a particular flying apparatus.

Corresponding reference characters indicate corresponding parts throughout the drawings.

### DETAILED DESCRIPTION

The various implementations will be described in detail with reference to the accompanying drawings. Wherever possible, the same reference numbers will be used throughout the drawings to refer to the same or like parts. References made throughout this disclosure relating to specific implementations and implementations are provided solely for illustrative purposes but, unless indicated to the contrary, are not meant to limit all implementations.

The foregoing summary, as well as the following detailed description of certain implementations will be better understood when read in conjunction with the appended drawings. As used herein, an element or step recited in the singular and preceded by the word “a” or “an” should be understood as not necessarily excluding the plural of the elements or steps. Further, references to “one implementation” are not intended to be interpreted as excluding the existence of additional implementations that also incorporate the recited features. Moreover, unless explicitly stated to the contrary, implementations “comprising” or “having” an element or a plurality of elements having a particular property could include additional elements not having that property.

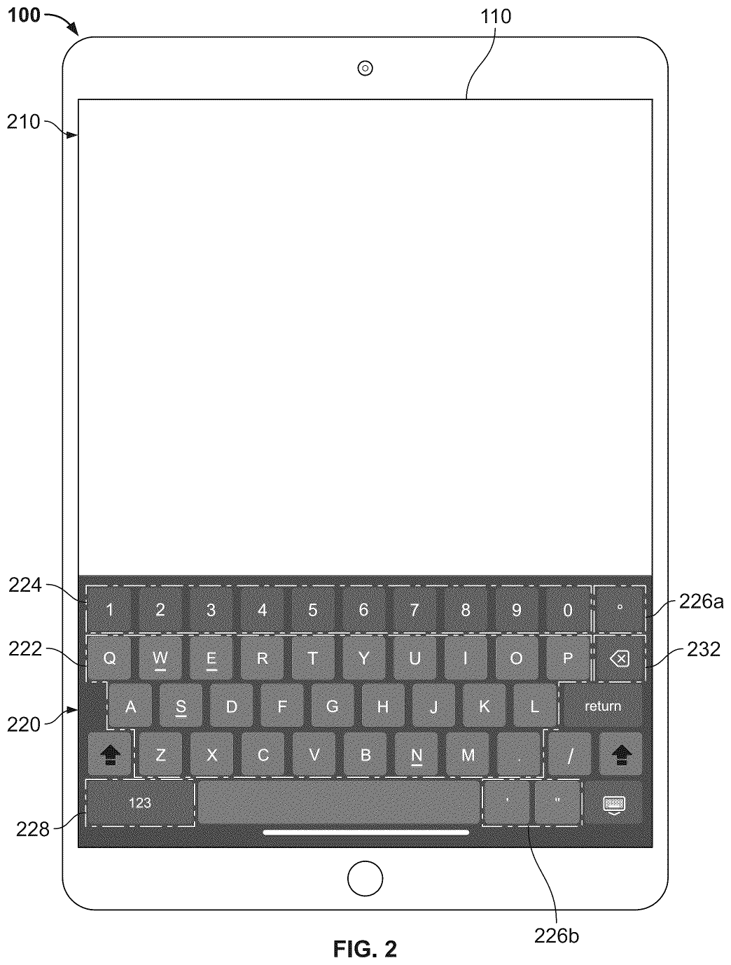

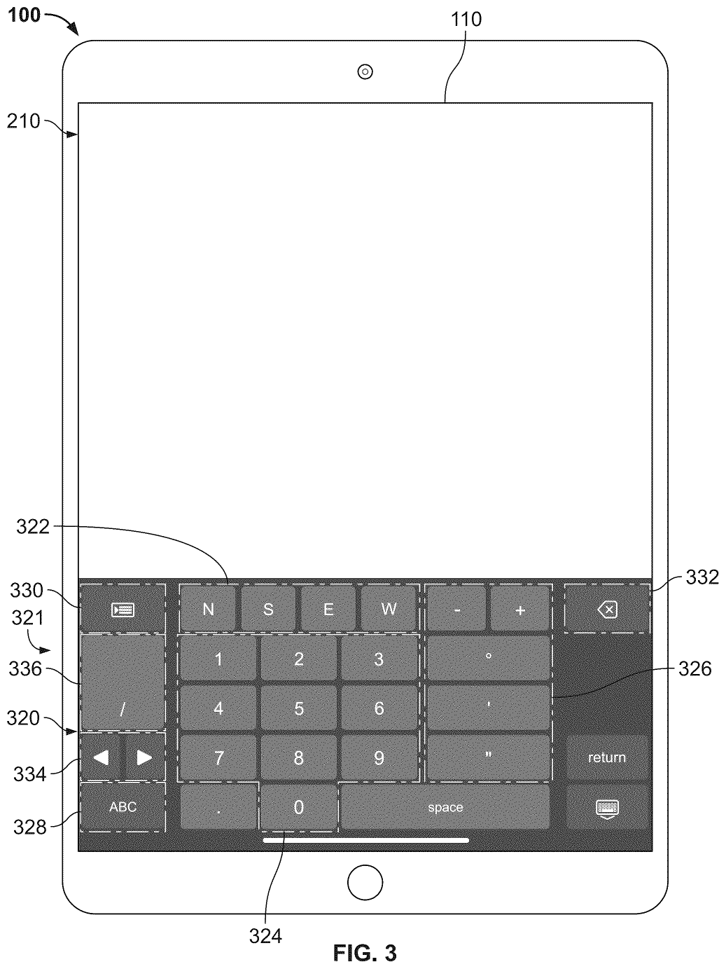

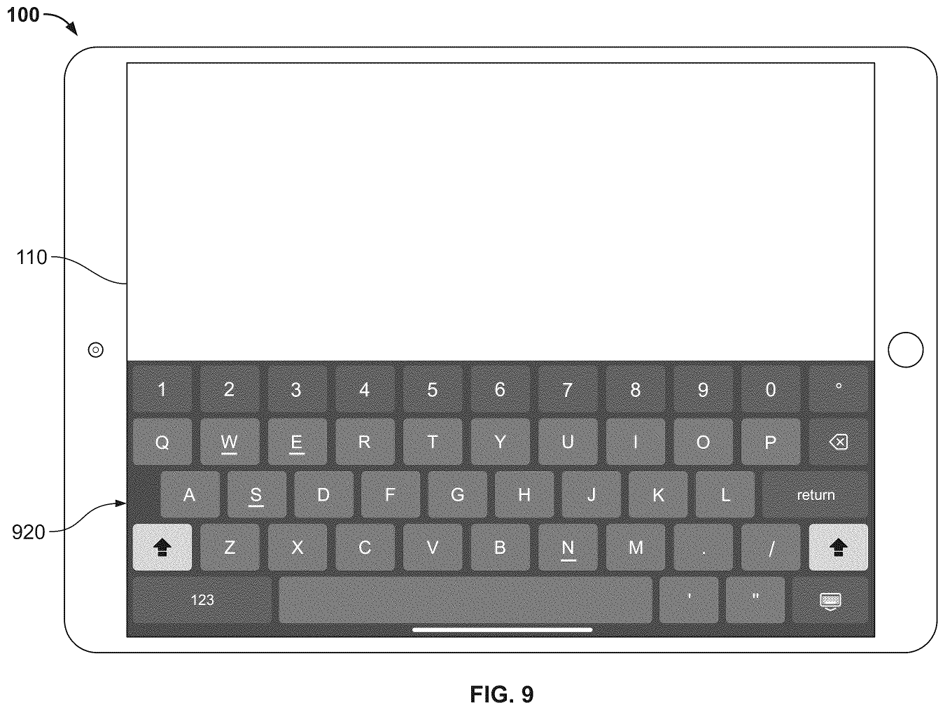

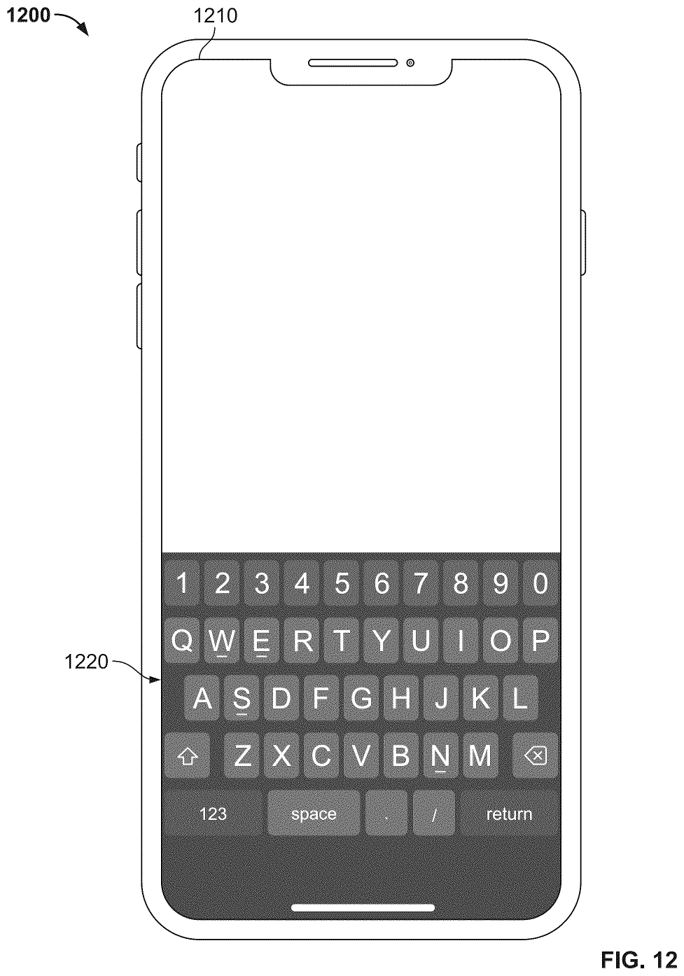

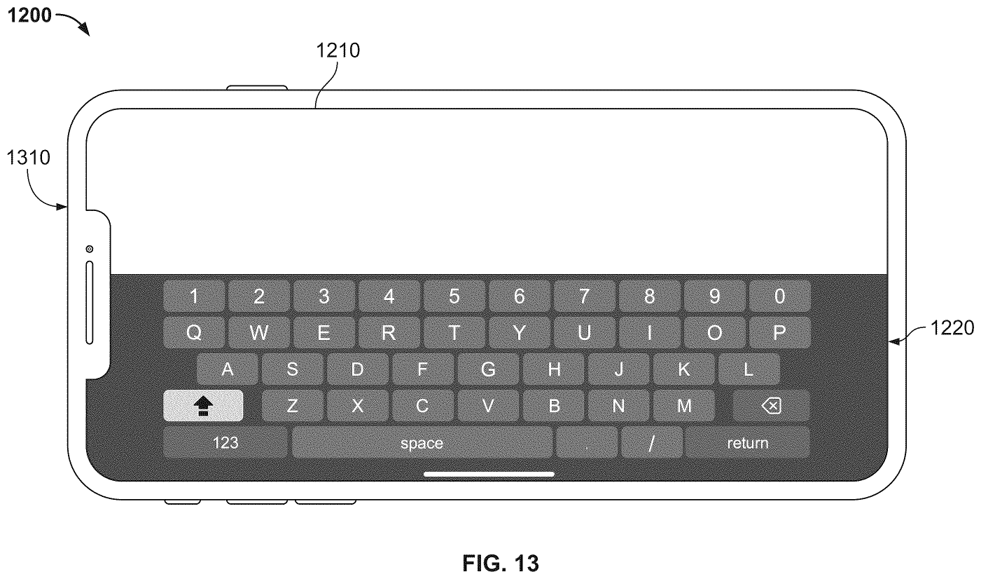

Referring to the figures, examples of the disclosure enable a flight navigation platform with a graphical user interface that provides improved entry of aviation coordinates. In some examples, the flight navigation platform selectively provides an abridged alphanumeric data keyboard and a condensed coordinate data keyboard via a touch-screen display of an electronic user device. The flight navigation platform arranges keys of the abridged alphanumeric data keyboard in a QWERTY configuration, such as shown in FIG. 2, FIG. 9, FIG. 12, and FIG. 13, and arranges keys of the coordinate data keyboard with a condensed configuration, such as shown in FIGS. 3 to 8, 10, 11, and 14 to 17. The configuration of such keyboards makes entering navigation coordinates easier by providing relevant keys that the user needs for entering such coordinates and flight information (e.g., by omitting at least some keys) within a streamlined arrangement. For example, the condensed configuration includes number keys arranged in a grid configuration, navigation letter keys arranged linearly adjacent to the grid configuration, and navigation symbol keys. The condensed configuration enables a more spatially efficient display of the keys that improves access to the keys with one hand by a user trying to enter navigation coordinate data, and can be alternately displayed with an abridged alphanumeric data keyboard in the QWERTY configuration such as shown in FIG. 12. The condensed configuration of the coordinate data keyboard and the abridged configuration of the alphanumeric data keyboard provide different levels of spatially efficient display as compared to a full size QWERTY keyboard that includes additional keys and symbols that are not needed for navigation data input (e.g., “;” key, “[” key,“]” key, “=” key).

Generally, the user may “anchor” one of their hands to the electronic user device (e.g., a tablet, smartphone) to provide improved stability of their hand relative to the touch-screen display, instead of holding their hand in a free-floating manner which may be challenging in a cockpit environment (e.g., due to aircraft maneuvering, turbulence, etc.). This anchored hand position provides improved stability to the user when attempting to accurately touch various keys on the touch-screen display with one hand (e.g., their thumb and/or fingers), but may reduce a region of the touch-screen display that is accurately reachable by the user.

In various examples, the flight navigation system determines an anchored reach region of the touch-screen display for the user (e.g., the region of the touch-screen display that is accurately and comfortably reachable by the user). The anchored reach region can be different in various scenarios and based on one or more of an orientation of the electronic user device (i.e., landscape left, landscape right, portrait, or inverted orientation), which hand the user has anchored (i.e., left or right hand), where the user's hand is anchored (e.g., bottom left or right corner, left or right side, upper left or right corner). The flight navigation system then generates the condensed configuration for the coordinate data keyboard based on the determined anchored reach region. This allows for easier one handed operation of the flight navigation system for users who keep one hand free to, for example, control an aircraft.

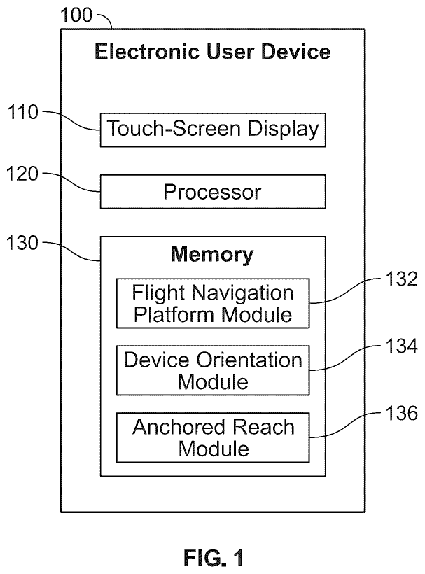

Referring more particularly to the figures, FIG. 1 is a block diagram of an electronic user device 100 for a flight navigation platform configured to provide different data entry keyboards. In the example of FIG. 1, the electronic user device 100 represents any device executing computer-executable instructions (e.g., as application programs, operating system functionality, or both) to implement the operations and functionality associated with the electronic user device 100. In various examples, the electronic user device 100 includes, for example but without limitation, a mobile smartphone, laptop, tablet, computing pad, netbook, and/or any other type of portable computing device.

As shown in FIG. 1, the electronic user device 100 includes a touch-screen display 110, a processor 120, and a memory 130. In some examples, the touch-screen display is an organic light emitting diode (OLED) display with a capacitive touch feature, such as a display on a smartphone or tablet. In other examples, the touch-screen display is another suitable display with a touch and/or pressure sensitive feature for receiving user inputs with a user's finger, thumb, a stylus, etc.

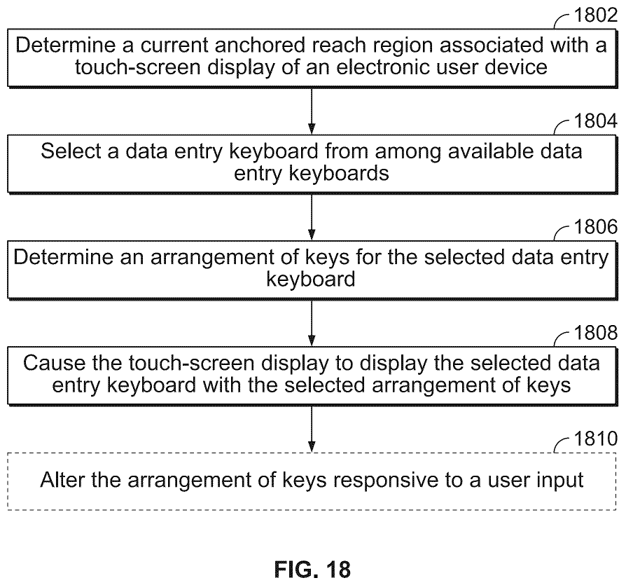

The processor 120 includes any quantity of processing units and is programmed to execute computer-executable instructions. The computer-executable instructions are performed by the processor 120, performed by multiple processors within the electronic user device 100, or performed by a processor external to the electronic user device 100. In some examples, the processor 120 is programmed to execute instructions for a method such as those illustrated in the figures (e.g., FIG. 18).

The electronic user device 100 further has one or more computer-readable media such as the memory 130. The memory 130 includes any quantity of media associated with or accessible by the electronic user device 100. The memory 130 in some examples is internal to the electronic user device 100 (as shown in FIG. 1). In other examples, the memory 130 is external to the electronic user device 100 (not shown) or both (not shown). The memory 130 can include read-only memory and/or memory wired into an analog computing device.

In various embodiments, the electronic user device 100 includes one or more modules that enable functionality as described herein. In other words, the modules form part of a control system for the electronic user device 100. In the example shown in FIG. 1, the electronic user device 100 includes a flight navigation platform module 132, a device orientation module 134, and an anchored reach module 136. In this example, the modules are implemented as software and/or firmware modules stored within the memory 130 and include instructions that when executed by the processor 120 cause and/or configure the processor to enable the functionality. In other embodiments, one or more of the modules, and/or portions thereof can be implemented using application-specific integrated circuits or other suitable hardware. The module(s) can communicate with counterpart modules, applications, and/or services, such as web services accessible via a network. In an example, the modules represent downloaded client-side applications that correspond to server-side services executing in a cloud.

The flight navigation platform module 132 is configured to provide a flight navigation platform or application via the electronic user device 100 to facilitate navigation of an aircraft. For example, the flight navigation platform module 132 is configured to receive navigation coordinate data from a user (e.g., via the different data entry keyboards) and to display route mapping and planning information, weather information, airport information, or other suitable information. The flight navigation platform module 132 may be referred to herein as the “flight navigation platform” for brevity. The device orientation module 134 is configured to determine a current orientation of the electronic user device 100. For example, the device orientation module 134 uses data from one or more of a gyroscope, accelerometer, and/or image sensor (not shown) of the electronic user device 100 and provides an indication of whether the electronic user device 100 is in a portrait orientation (or inverted) or a landscape (left or right) orientation. The anchored reach module 136 is configured to determine an anchored reach region for a user of the electronic user device 100. For example, the anchored reach module 136 determines an anchored hand position of the user and determines the anchored reach region for that user based on one or more of the anchored hand position and the current orientation of the electronic user device 100. In some examples, the anchored reach module 136 uses one or more default anchored reach regions for the electronic user device 100 (e.g., using left and right anchored reach regions without customization to a particular user).

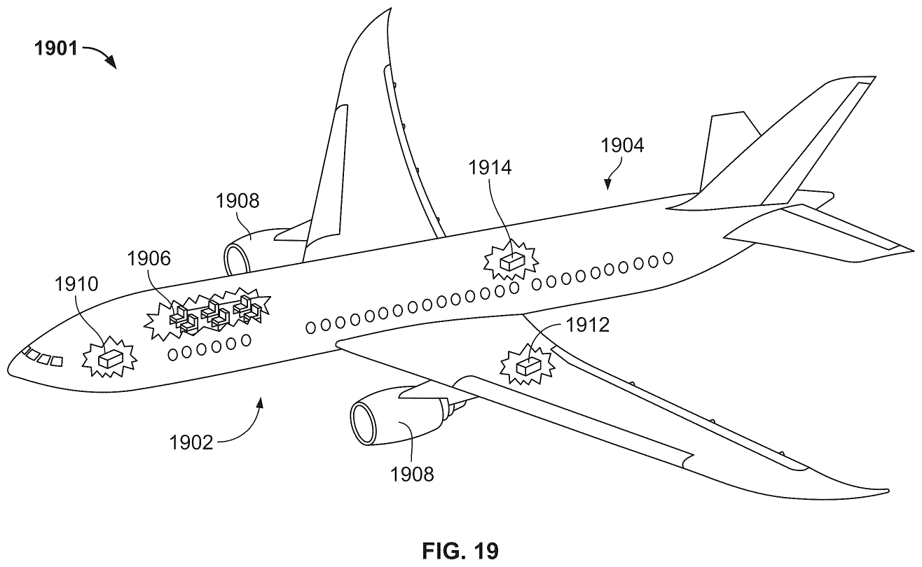

The electronic user device 100 shown in FIG. 1 is depicted as a stand-alone computing device. However, in other examples, the computing device may be a device hardwired or installed on board an aircraft, such as the aircraft 1901 illustrated in FIG. 19. The aircraft may be implemented as an airplane, helicopter, or other transportation vehicle. In still other examples, the electronic user device 100 can be a portable user device carried or utilized on-board an aircraft. In yet other examples, the electronic user device 100 can be a computing device installed within an aircraft which is removable, rather than hardwired into the aircraft.

FIG. 2 illustrates a portrait orientation of an abridged alphanumeric data keyboard 220 provided by the electronic user device 100 according to an implementation. The abridged alphanumeric data keyboard may be referred to herein as the alphanumeric data keyboard for brevity. More specifically, the flight navigation platform 132 causes the touch-screen display 110 to display a graphical user interface that includes a content region 210 and an alphanumeric data keyboard 220. For clarity, the content region 210 is empty, but can include map information, weather information, aircraft information, etc. In this example, the electronic user device 100 is implemented as a tablet.

The alphanumeric data keyboard 220 includes first letter keys 222, number keys 224, navigation symbol keys 226, and other keys (not labeled). The first letter keys 222 include keys for letters A to Z arranged in a QWERTY configuration. The number keys 224 include keys for numbers 0 to 9 and are arranged in a horizontal row above an uppermost horizontal row of the QWERTY configuration. Although a QWERTY configuration is shown for the first letter keys 222, the flight navigation platform 132 can cause the alphanumeric data keyboard 220 to be displayed with an alternate keyboard configuration for the first letter keys 222, such as a Dvorak configuration, in other examples.

In some examples, each of the number keys 224 is horizontally aligned with a letter key of the uppermost horizontal row. In the example shown in FIG. 1, the 1 key is horizontally aligned with and located above the Q letter key, the 2 number key is horizontally aligned with and located above the W letter key, etc. In some scenarios, this alignment of the number keys 224 with the uppermost horizontal row of the letter keys 222 provides a location of the number keys 222 on the touch-screen display that is more visually intuitive to the user.

In the example shown in FIG. 2, the flight navigation platform 132 causes navigational letter keys (i.e., N, S, E, and W) to be displayed on the alphanumeric data keyboard 220 with underlining for improved visual contrast as compared to other, non-navigational letters without underlining. In some scenarios, the underlining enables a user to more easily identify and accurately touch the N letter key and avoid an accidental touch of the similar M letter key. In other examples, the flight navigation platform 132 uses other suitable visual identifiers for the navigational letter keys, such as different colors, font faces, font sizes, differentiating border and/or bolding.

As shown in the example of FIG. 2, the alphanumeric data keyboard 220 includes one or more navigation symbol keys, shown as navigation symbol keys 226, including navigation symbol key 226a for degrees (°) and navigation symbol keys 226b for minutes (′) and seconds (″). In other examples, the flight navigation platform 132 causes the alphanumeric data keyboard 220 to include additional navigation symbol keys (e.g., for plus, minus), fewer navigation symbol keys, or omits the navigation symbol keys.

The other keys can include function keys such as keys for directing cursor position movement within a graphical user interface of the flight navigation platform 132, for a character deletion function (e.g., function key 232), or other suitable function keys. The other keys can also include a key 336 for a “/” symbol that is specific for navigation data entry using the flight navigation platform 132.

As described above, the abridged alphanumeric data keyboard preferably omits various keys not used for entry of coordinate or flight information. This features provides a spatially efficient display of keys for flight data entry, as compared to a full size QWERTY keyboard that includes additional keys and symbols that are not needed for navigation data input, such as for example, the semicolon (“;”) key, the open and closed bracket (“[” and “]”) key, or the equal-sign (“=”) key.

The abridged alphanumeric data keyboard 220, although more concise than a full size QWERTY keyboard, spans the entire width of the touch-screen display 110 as shown in FIG. 2, which may require a user to float their hand above the touch-screen device, identify, and touch a desired key for data entry while in a turbulent cockpit environment. In other examples, the abridged alphanumeric data keyboard 220 can be displayed as a “floating” keyboard that does not span the entire width of the touch-screen display 110, but still includes additional keys that are less frequently used for navigation data input. As described above, the flight navigation platform 132 is configured to provide different data entry keyboards, such as one or more condensed coordinate data keyboards. As described above, the condensed coordinate data keyboard makes entering navigation coordinates easier by providing relevant keys that users more frequently use for entering such coordinates within a streamlined arrangement. Examples of such condensed coordinate data keyboards are shown in FIGS. 3 to 8, 10 to 11, and 14 to 17, described below.

As shown in the example of FIG. 2, the flight navigation platform 132 causes the alphanumeric data keyboard 220 to include a keyboard selection key 228. In certain examples, the flight navigation platform 132 is configured to selectively cause the touch-screen display 110 to display another data entry keyboard, such as the condensed coordinate data keyboards, responsive to a user input via the keyboard selection key 228.

FIG. 3 is a diagram of the electronic user device 100 of FIG. 1, illustrating a portrait orientation of a condensed coordinate data keyboard 320 having a left justified arrangement 321 of keys according to an implementation. The condensed coordinate data keyboard 320 comprises a first condensed configuration having number keys 324 arranged in a grid configuration, second letter keys 322 that are arranged linearly adjacent to the grid configuration, navigation symbol keys 326, and other keys (not labeled).

The number keys 324 include keys for numbers 0 to 9 and thus are the same numbers as shown in the alphanumeric data keyboard 220, but the flight navigation platform 132 displays the number keys 324 in the grid configuration for improved data entry. In the example shown in FIG. 3, the grid configuration is a numerical keypad configuration associated with a telephone. That is, keys for numbers 1, 2, and 3 are in an uppermost row of the keypad, keys for numbers 4 to 6 are in a middle row, and keys for 7 to 9 are in a bottommost row of the keypad. In other examples, the flight navigation platform 132 displays the grid configuration in a numerical keypad configuration associated with a keyboard. That is, the uppermost row and the bottommost row are switched.

The second letter keys 322 are arranged in a horizontal row above an uppermost row of the grid configuration of the number keys 324. The second letter keys 322 differ from the first letter keys 222 at least in that they omit keys that are not used (or less frequently used) for navigation data entry. That is, the second letter keys 322 are a subset of the first letter keys 222. In the example shown in FIG. 3, the second letter keys 322 include keys for letters N, S, E, and W associated with cardinal directions and may be referred to herein as navigation letter keys or cardinal direction keys. In other examples, the second letter keys 322 include the cardinal direction keys and also ordinal direction keys (i.e., NE, SE, SW, NW).

In the example shown in FIG. 3, the navigation symbol keys 326 include keys for navigation coordinate symbols plus, minus, degrees, minutes, and seconds. The navigation symbol keys 326 are arranged in a column that is adjacent to the grid configuration of the number keys 324, shown on a right side of the grid configuration. In other examples, the navigation symbol keys 326 can include additional or fewer navigation symbol keys. Similarly to the letter keys, the flight navigation platform 132 causes the condensed coordinate keyboard 320 to include a subset of available symbol keys and omits keys for symbols that are not used (or less frequently used) for navigation data entry. For example, the flight navigation platform 132 omits keys for symbols * and # that are typically found in a numerical keypad configuration associated with a telephone.

In some examples, the condensed coordinate data keyboard 320 includes only keys that correspond to valid user inputs for navigation coordinate data entry. For example, only the number keys 0 to 9, the cardinal direction keys, the navigation symbol keys, and relevant function keys.

As shown in the example of FIG. 3, the condensed coordinate data keyboard 320 includes a keyboard selection key 328. In certain examples, the flight navigation platform 132 is configured to selectively cause the touch-screen display 110 to display another data entry keyboard, such as the alphanumeric data keyboard 220, responsive to a user input via the keyboard selection key 328. That is, the keyboard selection key 228 and the keyboard selection key 328 act as a toggle for alternately selecting the data entry keyboards according to the user input.

As indicated above, the condensed coordinate data keyboard 320 shown in FIG. 3 has a left justified arrangement 321. In certain examples, such as shown in FIG. 3, the flight navigation platform 132 causes the condensed coordinate data keyboard 320 to include an arrangement selection key 330. Responsive to user inputs received via the arrangement selection key 330, the flight navigation platform 132 alters a key arrangement of a currently displayed keyboard between the left justified arrangement 321 and a right justified arrangement of keys, such as described below.

The other keys of the condensed coordinate data keyboard 320 can include function keys such as keys for directing cursor position movement within a graphical user interface of the flight navigation platform 132 (e.g., function keys 334), for a character deletion function (e.g., function key 332), or other suitable function keys.

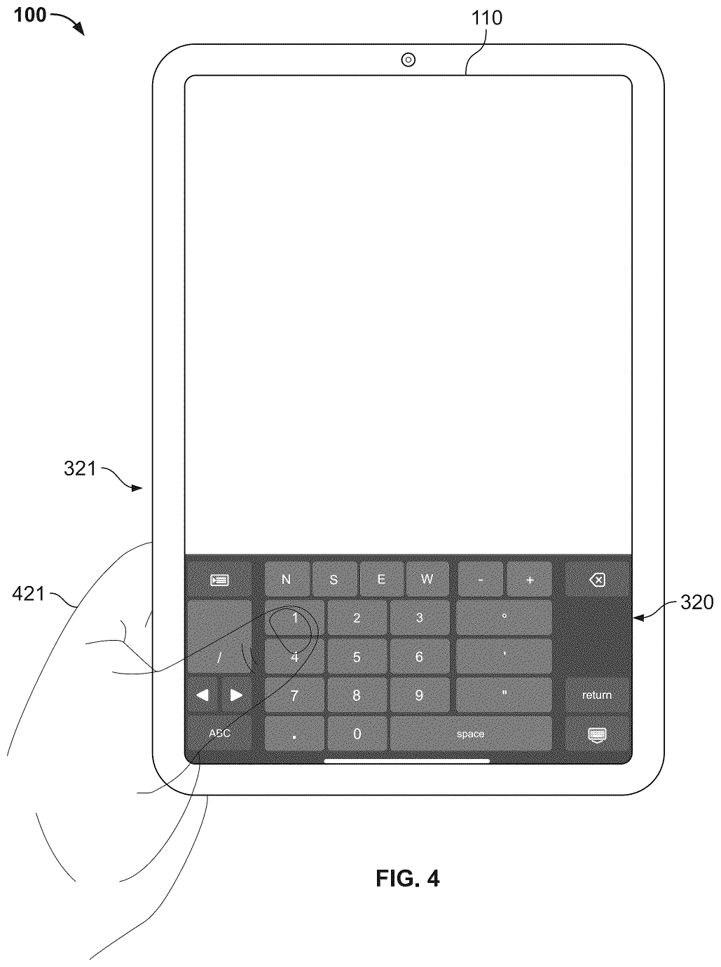

FIG. 4 is a diagram of the electronic user device 100 of FIG. 1, illustrating the portrait orientation of the condensed coordinate data keyboard 320 having the left justified arrangement 321 of keys with a left anchored user hand 421 (shown in outline) of a user according to an implementation. The left anchored user hand 421 is anchored to a bottom left corner of the electronic user device 100. As can be seen in FIG. 4, the left justified arrangement 321 of the keys is biased towards the left anchored user hand 421 (e.g., towards a left portion of the touch-screen display 110), which can improve access to the keys by the user when trying to enter navigation coordinate data.

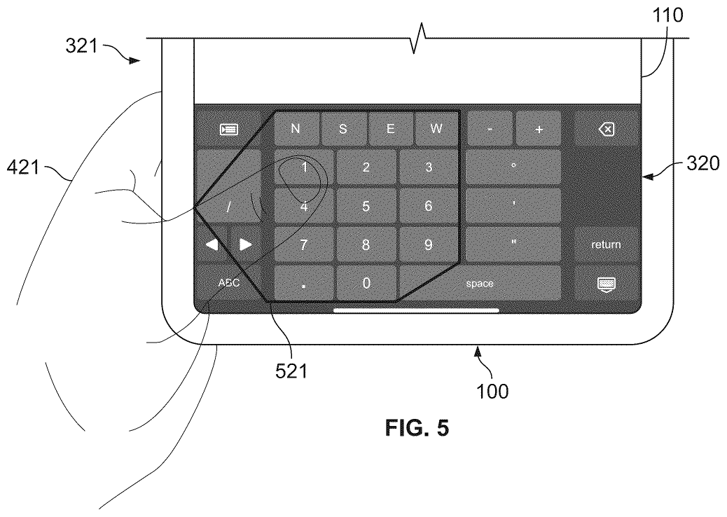

FIG. 5 is a diagram of the electronic user device 100 of FIG. 1, illustrating the portrait orientation of the condensed coordinate data keyboard 320 having the left justified arrangement 321 of keys with a left anchored reach region 521 according to an implementation. As described above, a region of the touch-screen display 110 that is reachable by the user can be different in various scenarios, for example, based upon one or more reach factors including, but not limited to: (1) an orientation of the electronic user device (i.e., landscape or portrait orientation); (2) which hand the user has anchored (i.e., left or right hand); (3) whether the user's anchored hand is their dominant hand or non-dominant hand; (4) where the user's hand is anchored (e.g., bottom left or right corner, left or right side, upper left or right corner); (5) flexibility of the user's hand; (6) lengths of the thumb and/or fingers of the user's hand; (6) or other factors.

In various examples, the flight navigation platform 132, via the device orientation module 134, determines the orientation of the electronic user device 100. As described above, the device orientation module 134 uses data from one or more sensors (e.g., gyroscope, accelerometer, and/or image sensor) of the electronic user device 100 to determine the orientation and then provides an indication of whether the electronic user device 100 is in a portrait orientation or a landscape orientation. In some examples, once initially determined and/or configured by the user, the orientation is a desired, fixed orientation. That is, the orientation is fixed to either the landscape orientation or the portrait orientation regardless of current data provided by the sensors of the electronic user device 100 (e.g., to prevent changes in orientation due to rolling and/or pitching of an aircraft in which the electronic user device 100 is used). In some examples, the device orientation module 134 dynamically determines the orientation using the current data.

In various examples, the flight navigation platform 132, via the anchored reach module 136, determines a current anchored reach region based on one or more of the above-mentioned reach factors and uses the anchored reach region to: (1) select a condensed coordinate data keyboard to be displayed from among available condensed coordinate data keyboards; (2) select an arrangement of keys for a condensed coordinate data keyboard; or (3) select both a condensed coordinate data keyboard to be displayed and an arrangement of keys for the selected condensed coordinate data keyboard.

In some examples, the flight navigation platform 132 uses one or more default anchored reach regions for the electronic user device 100 (e.g., using left and right anchored reach regions without customization to a particular user). In other examples, the flight navigation platform 132 provides a reach assessment graphical user interface (not shown) configured to determine the anchored reach region for the user in one or more orientations of the electronic user device 100 and/or anchored hand positions. For example, the reach assessment graphical user interface enables a user to indicate their anchored reach region by touching one or more locations on the touch-screen display 110.

As can be seen in FIG. 5, at least some of the keys of the condensed coordinate data keyboard 320 are arranged outside of the anchored reach region 521 while other keys are arranged within the anchored reach region 521. In some examples, the arrangement of the keys is fixed within a particular arrangement, such as the left justified arrangement 321. In other examples, the flight navigation platform 132 dynamically determines which keys are to be arranged within or outside of the anchored reach region 521, for example, based on a size of the anchored reach region 521, a user indicated preference, a frequency of use for the keys (for navigation data entry or other use), or other suitable factors. As shown in FIG. 5, the flight navigation platform 132 arranges the second letter keys 322 and the number keys 324 within the anchored reach region 521 and arranges the navigation symbol keys 326 outside of the anchored reach region 521.

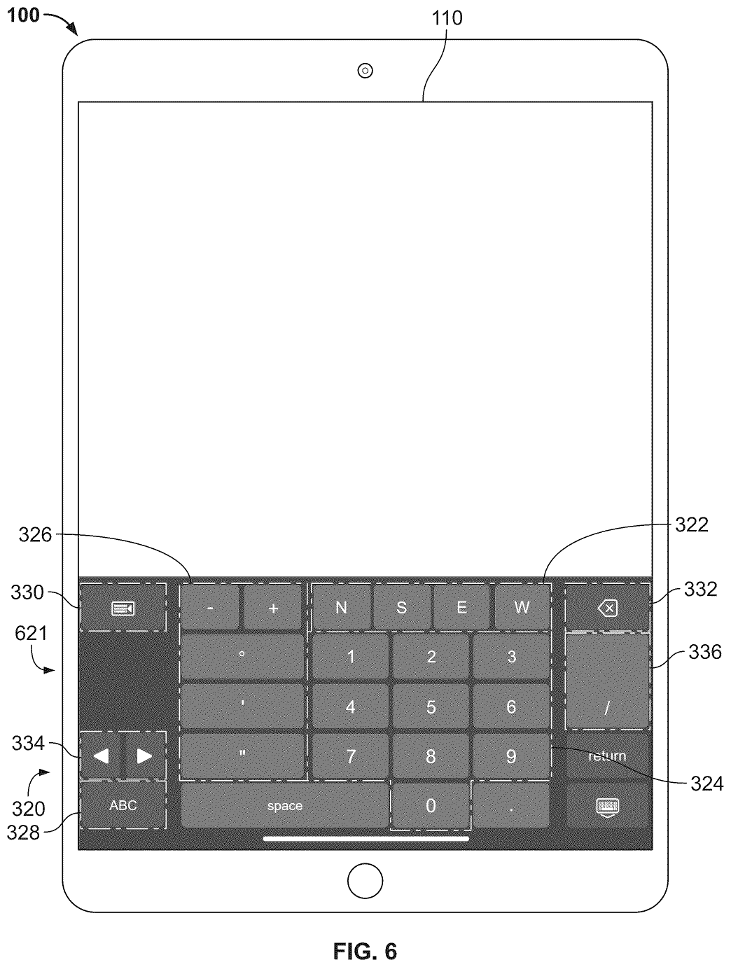

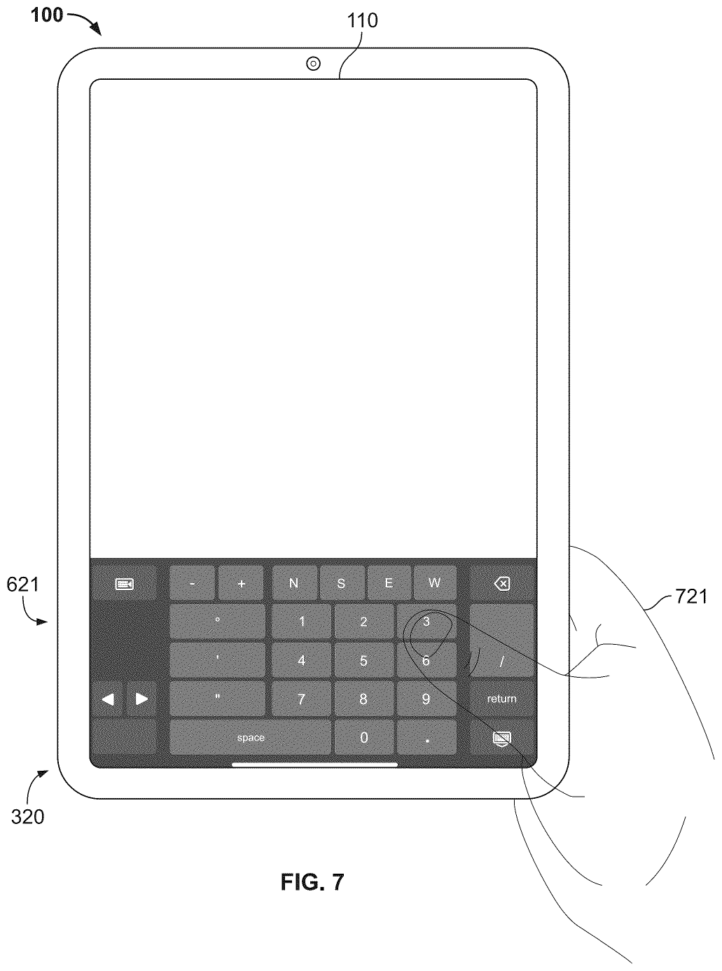

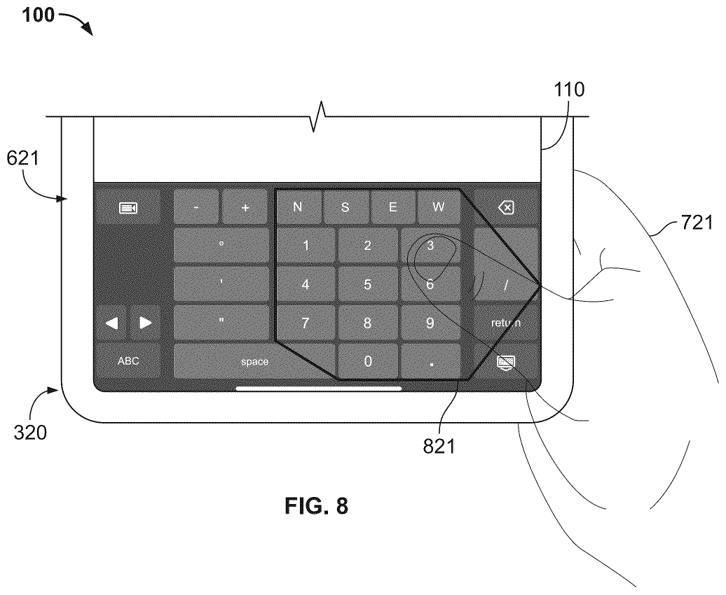

FIG. 6 is a diagram of the electronic user device 100 of FIG. 1, illustrating a portrait orientation of the condensed coordinate data keyboard 320 having a right justified arrangement 621 of keys according to an implementation. FIG. 7 is a diagram of the electronic user device 100 of FIG. 1, illustrating the portrait orientation of the condensed coordinate data keyboard 320 having the right justified arrangement 621 of keys with a right anchored user hand 721 according to an implementation. FIG. 8 is a diagram of the electronic user device 100 of FIG. 1, illustrating the portrait orientation of the condensed coordinate data keyboard 320 having the right justified arrangement 621 of keys with a right anchored reach region 821 according to an implementation.

The right anchored user hand 721 is anchored to a bottom right corner of the electronic user device 100. In the examples shown in FIGS. 6 to 8, the number keys 324 are again arranged in the grid configuration, but the column of the navigation symbol keys 326 is arranged on an opposite, left side of the grid configuration. That is, the right justified arrangement 621 of the keys includes the same keys as the left justified arrangement 621, but is biased towards the right anchored user hand 721 (e.g., towards a right portion of the touch-screen display 110), which can improve access to the keys by the user when trying to enter navigation coordinate data. As described above, responsive to user inputs via the arrangement selection key 330, the flight navigation platform 132 alters a key arrangement of a currently displayed keyboard between the left justified arrangement 321 and the right justified arrangement 621.

Although the left justified arrangement 321 and the right justified arrangement 621 of the condensed coordinate data keyboard 320 are described herein, other arrangements are contemplated and within the scope of the present disclosure. Moreover, the left justified arrangement 321 and the right justified arrangement 621 include the same keys, but other arrangements in other examples can include different quantities and/or sizes of the keys. In some examples, a left justified arrangement includes additional keys and/or smaller keys as compared to a right justified arrangement, for example, to accommodate a left-handed dominant user with more dexterity in their left hand.

FIG. 9 is a diagram of the electronic user device 100 of FIG. 1, illustrating a landscape orientation of an abridged alphanumeric data keyboard 920 according to an implementation. The alphanumeric data keyboard 920 generally corresponds to the alphanumeric data keyboard 220 and is displayed on the electronic user device 100 implemented as a tablet, but in the landscape left orientation instead of the portrait orientation. As can be seen in FIG. 9, the alphanumeric data keyboard 920 spans the entire width of the touch-screen display 110 (or alternatively, spans a region with a floating keyboard implementation), which may require a user to float their hand above the touch-screen device, identify, and touch a desired key for data entry while in a turbulent cockpit environment.

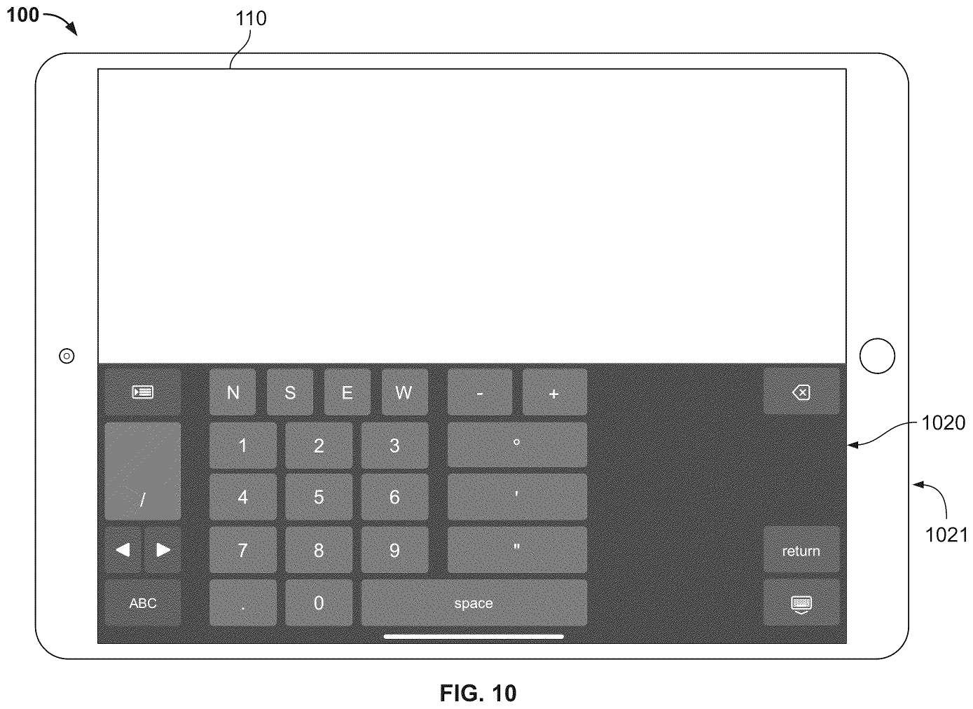

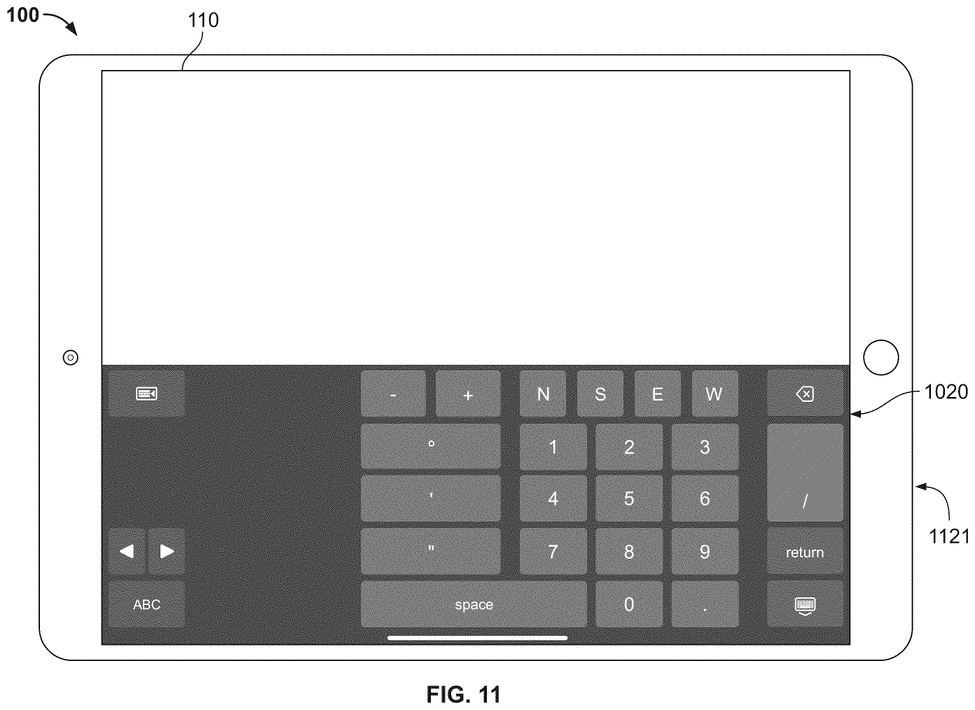

FIG. 10 is a diagram of the electronic user device 100 of FIG. 1, illustrating a landscape left orientation of a condensed coordinate data keyboard 1020 having a left justified arrangement 1021 of keys according to an implementation. FIG. 11 is a diagram of the electronic user device 100 of FIG. 1, illustrating a landscape orientation of the condensed coordinate data keyboard 1020 having a right justified arrangement 1121 of keys according to an implementation. The condensed coordinate data keyboard 1020 generally corresponds to the condensed coordinate data keyboard 320, but in the landscape orientation instead of the portrait orientation. As described above, the flight navigation platform 132 is configured to selectively cause the touch-screen display 110 to display various data entry keyboards, such as the alphanumeric data keyboard 920 or the condensed coordinate data keyboard 1020. Moreover, the flight navigation platform 132 can alter a key arrangement of the condensed coordinate data keyboard between the left justified arrangement 1021 and the right justified arrangement 1121.

FIG. 12 is a diagram of another electronic user device 1200, for the flight navigation platform 132, configured to provide different data entry keyboards and illustrating a portrait orientation of an abridged alphanumeric data keyboard 1220 according to an implementation. FIG. 13 is a diagram of the electronic user device 1200 of FIG. 12, illustrating a landscape orientation of the abridged alphanumeric data keyboard 1220 according to an implementation. The alphanumeric data keyboard 1220 generally corresponds to the alphanumeric data keyboard 220 and has a QWERTY configuration, but with fewer keys (i.e., omitting the navigation symbol keys 226b for minutes and seconds). In this example, the electronic user device 1200 generally corresponds to the electronic user device 100 (i.e., including a touch-screen display 1210, the processor 120, and the memory 130), but is implemented as a smartphone. As can be seen in FIG. 12, the alphanumeric data keyboard 1220 spans the entire width of the touch-screen display 1210 (or alternatively, spans a region with a floating keyboard implementation), which may require a user to float their hand above the touch-screen device, identify, and touch a desired key for data entry while in a turbulent cockpit environment. Accordingly, even for a smaller electronic user device such as a smartphone (or tablet with the keyboard is floating within a portion of the screen), the abridged alphanumeric data keyboard 1220, while more efficient for navigation data entry than a full size QWERTY keyboard, can still be less efficient for navigation data entry than the condensed coordinate data keyboards described above. Similar to the examples described above, the flight navigation platform 132 of the electronic user device 1200 is configured to provide different data entry keyboards, such as the condensed coordinate data keyboard 320 and the abridged alphanumeric data keyboard 1220.

As shown in FIG. 13, the electronic user device 1200 includes a camera bump 1310 that extends into the touch-screen display 1210. The camera bump 1310 includes a region of the touch-screen display 1210 that is less responsive (or not responsive) to user inputs because of the presence of an image sensor (i.e., a front-facing camera). In some examples, the flight navigation platform 132 arranges the keys of the condensed coordinate data keyboard 320 to avoid the camera bump 1310. That is, the flight navigation platform 132 arranges the keys further to a right side of the touch-screen display 1210 when the electronic user device 1200 is in a landscape left orientation as shown in FIG. 13. In some embodiments, the flight navigation platform 132 arranges the keys of the condensed coordinate data keyboard 320 to avoid other regions of the touch-screen display 1210 that are less responsive (or not responsive) to user inputs for navigation data entry, such as a dynamic island region, a hole punch camera region, a facial scan unit region, a status bar region, a system bar region, and/or other region.

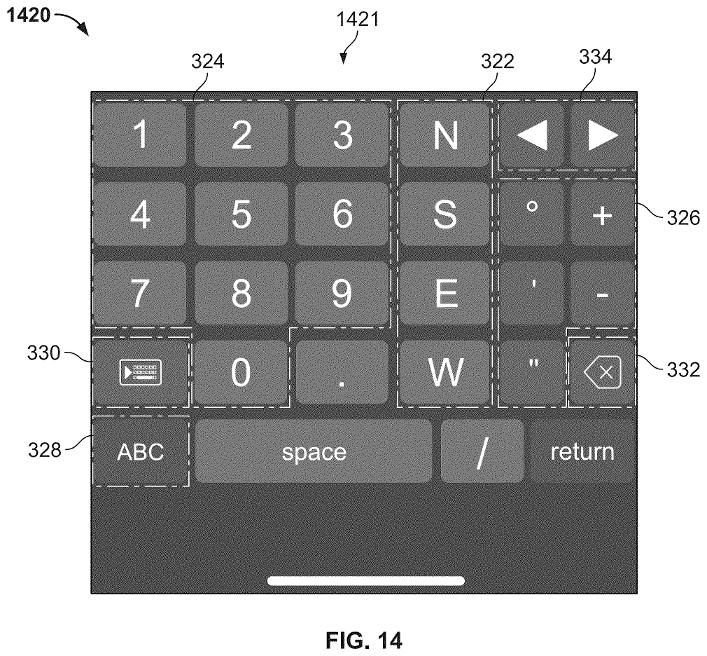

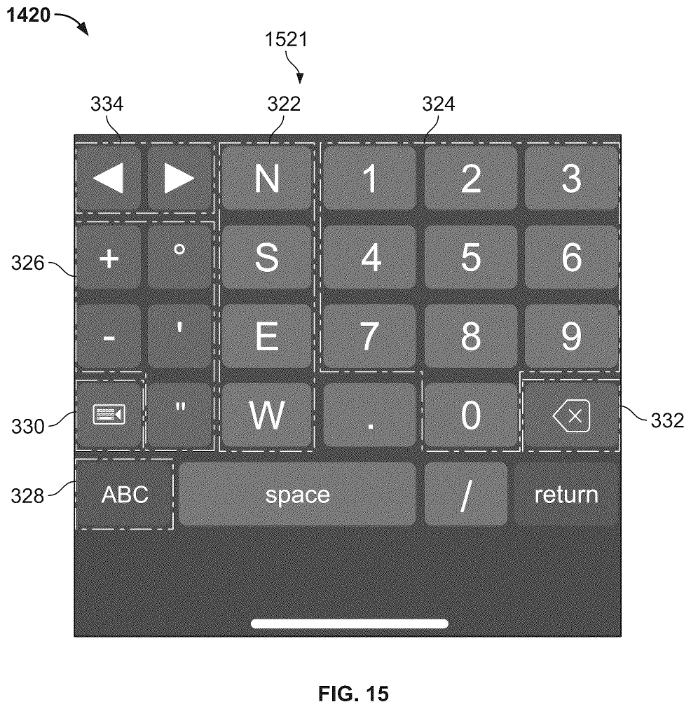

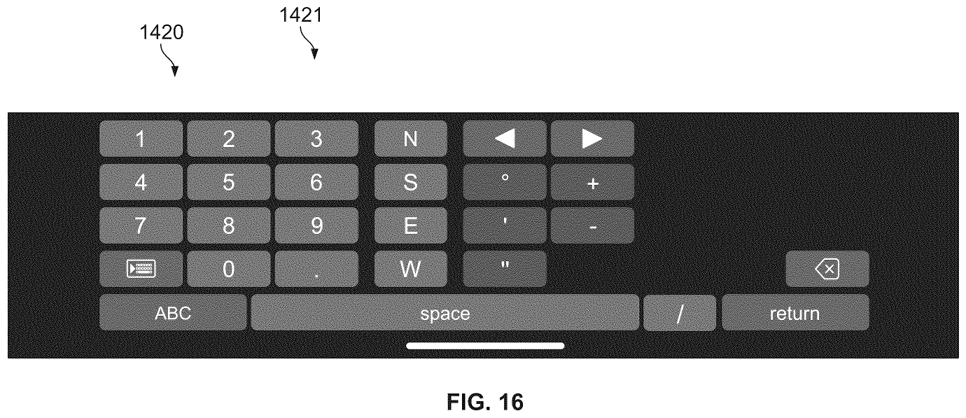

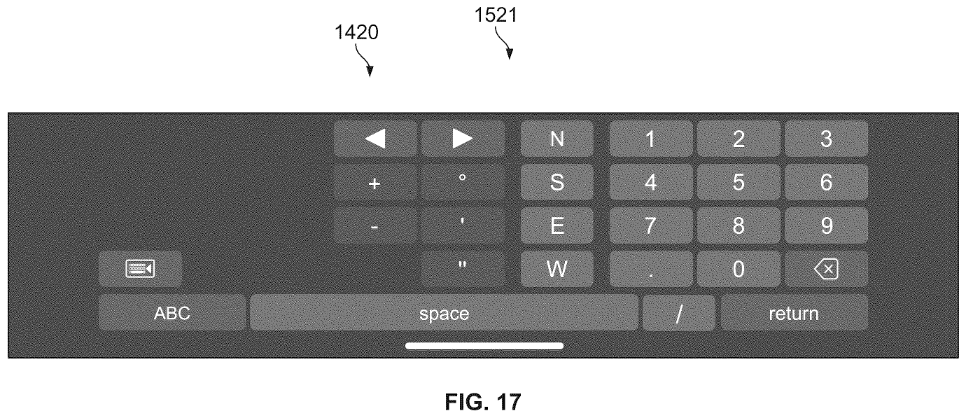

FIG. 14 is a diagram of another condensed coordinate data keyboard 1420 having a left justified arrangement 1421 of keys in a portrait orientation according to an implementation. FIG. 15 is a diagram of the condensed coordinate data keyboard 1420 having a right justified arrangement 1521 of keys in a portrait orientation according to an implementation. FIG. 16 is a diagram of the condensed coordinate data keyboard 1420 having the left justified arrangement 1421 of keys in a landscape orientation according to an implementation. FIG. 17 is a diagram of the condensed coordinate data keyboard 1420 having the right justified arrangement 1521 of keys in a landscape orientation according to an implementation.

The condensed coordinate data keyboard 1420 generally corresponds to the condensed coordinate data keyboard 320, but includes an alternate arrangement of the second letter keys 322 (i.e., cardinal direction keys) to the left and right side of the grid configuration of the number keys 324.

Although several examples of the condensed coordinate data keyboard and the abridged alphanumeric data keyboard are described herein, other examples and/or variations of the condensed coordinate data keyboard and/or the abridged alphanumeric data keyboard are contemplated and within the scope of the present disclosure. Other examples of the condensed coordinate data keyboard and/or the abridged alphanumeric data keyboard can include different quantities of keys, different arrangements of the keys, and/or different sizes of the keys. In some examples, different groups of keys have different sizes (e.g., larger number keys than cardinal direction keys). In some examples, the condensed coordinate data keyboard includes navigation letter keys (cardinal and/or ordinal direction keys) arranged around a perimeter of the grid configuration of the number keys, for example, with an N key arranged above the grid configuration, the E key arranged to the right of the grid configuration, etc. In various examples, data keyboards described above as being provided by the electronic user device 100, or other suitable data keyboards, can be provided by the electronic user device 1200 or other suitable user device. Similarly, data keyboards described above as being provided by the electronic user device 1200, or other suitable keyboards, can be provided by the electronic user device 100 or other suitable user device.

FIG. 18 shows a flowchart of an example method 1800 of displaying a data entry keyboard, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 18. Steps may be performed serially, in a partially overlapping manner, or fully in parallel. Thus, the order in which steps of method 1800 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 18 may be performed by the electronic user device 100 (e.g., via the processor 120), or other suitable computing device.

Method 1800 begins with step 1802. At step 1802, a current anchored reach region associated with an electronic user device is determined. For example, the anchored reach module 136 determines the current anchored reach region as the anchored reach region 521 (FIG. 5), the anchored reach region 821 (FIG. 8), or a different anchored reach region.

As described above, the anchored reach module 136 can determine the anchored reach region according to one or more reach factors, including but not limited to: (1) an orientation of the electronic user device (e.g., landscape or portrait orientation); (2) which hand the user has anchored (i.e., left or right hand); (3) whether the user's anchored hand is their dominant hand or non-dominant hand; (4) where the user's hand is anchored (e.g., bottom left or right corner, left or right side, upper left or right corner); (5) flexibility of the user's hand; (6) lengths of the thumb and/or fingers of the user's hand; (6) or other factors.

In some examples, step 1802 includes determining the orientation of the electronic user device, such as the electronic user device 100, using the device orientation module 134.

In some examples, the anchored reach module 136 determines the current anchored reach region by selecting from among default anchored reach regions for the electronic user device 100 (e.g., using left and right anchored reach regions without customization to a particular user). In other examples, the anchored reach module 136 determines the current anchored reach region based on reach factors that are specific to a current user.

In some examples, the anchored reach module 136 uses the touch-screen display 110 or another suitable capacitive touch sensor (not shown) to determine the anchored hand position of the user. For example, when a palm of the left anchored user hand 421 touches (e.g., inadvertently) a left edge of the touch-screen display 110 as the user holds or contacts the electronic user device 100, the anchored reach module can determine a left anchored hand position from inputs via the touch-screen display 110 associated with the left edge by an inadvertent touch of the user's palm.

In some examples, the anchored reach module 136 uses an image of the user captured by the image sensor to determine the anchored hand position of the user. For example, the anchored reach module 136 can determine a left anchored hand position from an image that includes a left arm and/or hand of the user.

At step 1804, a data entry keyboard is selected from among available data entry keyboards. For example, the flight navigation platform 132 selects the data entry keyboard as described herein. In various examples, the available data entry keyboards can include one or more of the alphanumeric data keyboard 220, the condensed coordinate data keyboard 320, the condensed coordinate data keyboard 1020, and the condensed coordinate data keyboard 1420. In one example, the available data entry keyboards include the alphanumeric keyboard 220 and the condensed coordinate data keyboard 320. In another example, the available data entry keyboards include the alphanumeric keyboard 220, the condensed coordinate data keyboard 320, and the condensed coordinate data keyboard 1020. In yet another example, the available data entry keyboards include the condensed coordinate data keyboard 320 and the condensed coordinate data keyboard 1020. In another example, the available data entry keyboards include only the condensed data keyboard 320.

At step 1806, an arrangement of keys for the selected data entry keyboard is selected. For example, the flight navigation platform 132 selects a left justified arrangement, a right justified arrangement, or another suitable arrangement for the selected data entry keyboard. As one example, the flight navigation platform 132 selects the left justified arrangement 321 for the condensed coordinate data keyboard 320 when the current anchored reach region is the left anchored reach region 521. As another example, the flight navigation platform 132 selects the right justified arrangement 621 for the condensed coordinate data keyboard 320 when the current anchored reach region is the right anchored reach region 821 In some examples, step 1806 includes determining key characteristics for one or more keys of the selected data entry keyboard. In some such examples, the flight navigation platform 132 determines one or more of visual identifiers (e.g., font color, font face, font size, underlining, bolding) for the keys (e.g., the first letter keys 222, the second letter keys 322, the number keys 224, the number keys 324, the navigation symbol keys 226, the navigation symbol keys 326, the keyboard selection key 328, the arrangement selection key 330, and/or other keys). In some such examples, the flight navigation system 132 determines sizes of the keys.

At step 1808, the touch-screen display is caused to display the selected data entry keyboard. For example, the flight navigation platform 132 causes the touch-screen display 110 of the electronic user device 100 to display the selected data entry keyboard.

In some examples, step 1806 is omitted and a default (or only) arrangement of keys is used for the selected data entry keyboard.

In some examples, the method 1800 further includes altering a key arrangement of a currently displayed data entry keyboard between a left justified arrangement of keys and a right justified arrangement of keys. For example, the flight navigation platform 132 alters the condensed coordinate data keyboard 320 between the left justified arrangement 321 and the right justified arrangement 621. In some examples, the flight navigation platform 132 alters the arrangement responsive to user inputs via the arrangement selection key 330. In some examples, the flight navigation platform 132 automatically alters the arrangement responsive to a change in orientation of the electronic user device 100, such as between a landscape left orientation, a landscape right orientation, a portrait orientation, and an inverted orientation.

With reference now to FIG. 19, a more specific diagram of a flying apparatus 1901 is depicted in which an implementation of the disclosure is advantageously employed. In this example, the flying apparatus 1901 includes an airframe 1902 with a plurality of systems 1904 and an interior 1906. Implementations of the plurality of systems 1904 include one or more of a propulsion system 1908, an electrical system 1910, a hydraulic system 1912, and an environmental system 1914. The system may be implemented in the aircraft navigation system or on a portable computing device utilized by a pilot within the aircraft. Other systems, not shown, are also candidates for inclusion. Although an aerospace example is shown, different advantageous implementations are applied to other industries, such as the automotive industry, etc.

Although described in connection with the electronic user device 100 depicted in FIG. 1, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

As indicated above, program code instructions may be stored in memory, and executed by processing circuitry that is thereby programmed, to implement functions of the systems, subsystems, tools, and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded, and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. It will also be understood that one or more functions, and combinations of functions, may be implemented by special purpose hardware-based computer systems and/or processing circuitry which perform the specified functions, or combinations of special purpose hardware and program code instructions.

The implementations disclosed herein are described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed implementations are practiced in a variety of system configurations, including personal computers, laptops, smart phones, mobile tablets, hand-held devices, consumer electronics, specialty computing devices, etc. The disclosed implementations are also practiced in distributed computing environments, where tasks are performed by remote-processing devices that are linked through a communications network.

When introducing elements of aspects of the disclosure or the implementations thereof, the articles “a,” “an,” “the,” and “said” are intended to mean that there are one or more of the elements. The terms “comprising,” “including,” and “having” are intended to be inclusive and mean that there could be additional elements other than the listed elements. The term “implementation” is intended to mean “an example of. ” The phrase “one or more of the following: A, B, and C” means “at least one of A and/or at least one of B and/or at least one of C.”

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of. ” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. As an illustration, the above-described implementations (and/or aspects thereof) are usable in combination with each other. In addition, many modifications are practicable to adapt a particular situation or material to the teachings of the various implementations of the disclosure without departing from their scope. While the dimensions and types of materials described herein are intended to define the parameters of the various implementations of the disclosure, the implementations are by no means limiting and are exemplary implementations. Many other implementations will be apparent to those of ordinary skill in the art upon reviewing the above description. The scope of the various implementations of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein. ” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A method for entry of navigation coordinate data in a flight navigation platform with a graphical user interface, using one or more processors in communication with a touch-screen display, the method comprising:
displaying, on the touch-screen display, one of a plurality of data entry keyboards, the plurality of data entry keyboards comprising:
an alphanumeric data keyboard comprising first letter keys arranged in a QWERTY configuration and number keys arranged in a horizontal row above an uppermost horizontal row of the QWERTY configuration, wherein each of the number keys is horizontally aligned with a letter key of the uppermost horizontal row; and
a condensed coordinate data keyboard comprising the number keys arranged in a grid configuration, second letter keys comprising letters N, S, E, and W linearly arranged adjacent to the grid configuration, and symbol keys comprising navigation coordinate symbols for plus, minus, degrees, minutes, and seconds,
wherein each of the plurality of data entry keyboards further comprises a keyboard selection key; and
responsive to a user input received via the keyboard selection key, selectively displaying, on the touch-screen display, another one of the plurality of data entry keyboards.

2. The method of claim 1, wherein the alphanumeric data keyboard comprises only the first letter keys, the number keys, the symbol keys, and function keys, and wherein each of the first letter keys, the number keys, the symbol keys, and the function keys correspond to valid user inputs for navigation coordinate data entry.

3. The method of claim 1, wherein at least one of the symbol keys comprises a symbol specific for navigation data entry using the flight navigation platform.

4. The method of claim 1, wherein each of the plurality of data entry keyboards comprises the symbol keys and function keys used for entry of navigation coordinate data.

5. The method of claim 4, wherein at least one of the symbol keys comprises a symbol specific for navigation data entry using the flight navigation platform.

6. The method of claim 1, wherein each of the plurality of data entry keyboards comprises at least one arrangement selection key, and the method further comprises:
responsive to user inputs via the arrangement selection key, altering, on the touch-screen display, a key arrangement of a currently-displayed keyboard of the plurality of data entry keyboards between a left justified arrangement of keys and a right justified arrangement of keys.

7. The method of claim 6, wherein altering the key arrangement comprises:
displaying the condensed coordinate data keyboard with the grid configuration on a right portion of the touch-screen display for the right justified arrangement of keys, and
displaying the condensed coordinate data keyboard with the grid configuration on a left portion of the touch-screen display for the left justified arrangement of keys.

8. The method of claim 7, wherein altering the key arrangement further comprises:
displaying the condensed coordinate data keyboard with the second letter keys on a left side of the grid configuration for the right justified arrangement of keys, and
displaying the condensed coordinate data keyboard with the second letter keys on a right side of the grid configuration for the left justified arrangement of keys.

9. The method of claim 6, wherein altering the key arrangement comprises:
displaying the condensed coordinate data keyboard with the second letter keys and the symbol keys on a left side of the grid configuration for the right justified arrangement of keys, and
displaying the condensed coordinate data keyboard with the second letter keys and the symbol keys on a right side of the grid configuration for the left justified arrangement of keys.

10. The method of claim 1, further comprising:
automatically altering, on the touch-screen display, a key arrangement of a currently-displayed keyboard of the plurality of data entry keyboards between a left justified arrangement of keys and a right justified arrangement of keys responsive to a change in orientation of the touch-screen display between a landscape left orientation and a landscape right orientation.

11. A method for entry of navigation coordinate data in a flight navigation platform with a graphical user interface, using one or more processors in communication with a touch-screen display, the method comprising,
displaying, on the touch-screen display, a condensed coordinate data keyboard for entry of navigation coordinate data, the condensed coordinate data keyboard comprising number keys arranged in a grid configuration, cardinal direction keys located adjacent to the grid configuration, and symbol keys comprising navigation coordinate symbols for plus (+), minus (−), degrees (°), minutes (′), and seconds (″), and an arrangement selection key; and
responsive to a user input received via the arrangement selection key, altering, on the touch-screen display, a key arrangement of the condensed coordinate data keyboard between a left justified arrangement of keys and a right justified arrangement of keys.

12. The method of claim 11, wherein altering the key arrangement of the condensed coordinate data keyboard displayed on the touch-screen display comprises: arranging the grid configuration on a right portion of the touch-screen display for the right justified arrangement of keys, and arranging the grid configuration on a left portion of the touch-screen display for the left justified arrangement of keys.

13. The method of claim 12, wherein altering the key arrangement of the condensed coordinate data keyboard displayed on the touch-screen display further comprises: aligning the cardinal direction keys in a first column on a left side of the grid configuration for the right justified arrangement of keys, and aligning the cardinal direction keys in a second column on a right side of the grid configuration for the left justified arrangement of keys.

14. The method of claim 11, wherein the symbol keys comprise at least one symbol key with a symbol specific for navigation data entry using the flight navigation platform.

15. The method of claim 11, wherein the condensed coordinate data keyboard further comprises function keys for directing cursor position movement within the graphical user interface and for a character deletion function.

16. A system for entry of navigation coordinate data in a flight navigation platform, the system comprising:
one or more processors;
a touch-screen display communicatively coupled to the one or more processors; and
a memory storing instructions that are operative, upon execution by the one or more processors, to cause the one or more processors to:
display, on the touch-screen display, a condensed coordinate data keyboard having cardinal direction keys, number keys of only digits zero through nine, symbol keys comprising navigation coordinate symbols for plus, minus, degrees, minutes, and seconds, and an arrangement selection key; and
responsive to a user input received via the arrangement selection key, dynamically alter, on the touch-screen display, a key arrangement of the condensed coordinate data keyboard between a left justified arrangement of keys and a right justified arrangement of keys, wherein the right justified arrangement positions the number keys on a right portion of the touch-screen display and the left justified arrangement positions the number keys on a left portion of the touch-screen display.

17. The system of claim 16, wherein the condensed coordinate data keyboard is initially displayed with the number keys arranged in a grid configuration having three columns and the cardinal direction keys arranged in a fourth column located adjacent to the grid configuration.

18. The system of claim 17, wherein dynamically altering the key arrangement to the right justified arrangement of keys comprises arranging the fourth column of cardinal direction keys on a left side of the grid configuration, and dynamically altering the key arrangement to the left justified arrangement of keys comprises arranging the fourth column of cardinal direction keys on a right side of the grid configuration.

19. The system of claim 16, wherein the symbol keys comprise at least one symbol key with a symbol specific for navigation data entry using the flight navigation platform.

20. The system of claim 16, wherein the instructions are operative, upon execution by the one or more processors, to further cause the one or more processors to automatically alter, on the touch-screen display, the key arrangement of the condensed coordinate data keyboard between the left justified arrangement of keys and the right justified arrangement of keys responsive to a change in orientation of the touch-screen display between a landscape left orientation and a landscape right orientation.
